(19) United States
(12) Patent Application Publication
(10) Pub. No.: US 2010/0110462 A1
(43) Pub. Date: May 6, 2010

(54) TEXTURE INFORMATION DATA ACQUIRING DEVICE AND DISPLAY CONTROL SYSTEM HAVING THE TEXTURE INFORMATION DATA ACQUIRING DEVICE

(75) Inventors: Yoshifumi Arai, Suwa-shi (JP); Kenji Fukasawa, Suwa-shi (JP); Hidekuni Moriya, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/612,357

(22) Filed: Nov. 4, 2009

(30) Foreign Application Priority Data
Nov. 4, 2008 (JP) 2008-283313

(51) Int. Cl. G06F 15/00

(52) U.S. Cl. 358/1.9

(57) ABSTRACT

There is provided a texture information data acquiring device that receives print data, which is used at the time of performing printing by using a printing apparatus and represents the amount of a print recording material used at the time of printing, as input, acquires texture information data that represents the texture of a printing surface of a printing material from the print data, and outputs the texture information data.

### BACKGROUND

1. Technical Field

The present invention relates to a technology for acquiring texture information data that represents the texture of a printing surface of a printing material.

2. Related Art

In a general color management process, the transfer of color information or match of color information between different color reproducing devices is implemented by using a characteristic descriptive file referred to as a profile that describes the color reproducing characteristics of each color reproducing device based on the ICC (International Color Consortium) standards and a color converting engine that converts the color information between different types of devices by using the information of the characteristic descriptive file. However, by using the above-described color management technology, only the color information can be handled, and the surface texture information such as gloss, metal gloss, roughness, or concavity and convexity cannot be handled.

In addition, in a case where a printing material having a metallic or embossing processing, wrinkles, or the like is generated as a highly value-added printing material, a time consuming operation requiring much labor such as designation of the color and the texture by using a sample patch or repetition of performing corrected printing in the presence of an ordering party many times in a correction process performed by a printing apparatus for finishing the final printing material has been performed. In addition, a highly value-added printing material can be generated only by using a method depending on a worker's sense.

Meanwhile, in the field of computer graphics, a technology for reproducing the realistic texture of the surface of an object on a display screen as a computer graphics image has been developed. In particular, 3D-CG generation software using an open source such as OpenGL or DirectX has been developed. Thus, by using such software, a realistic image that may be taken for a real photograph can be generated in consideration of both direct light and indirect light by artificially generating various texture attributes of the surface of an object such as gloss, concavity and convexity, transparency, and roughness. Therefore, generally, such software has been widely used in an SF movie, game software, or the like. Moreover, recently, software that enables a user to check the design of a product, the coating state of the surface of a product, or the like on the display screen has been developed and shipped to the market. Thus, by using such software, generation of a mock-up can be suppressed to be the minimum in the development of the design of a car, clothes, or a general product or the like, and accordingly, the efficiency of the product development is increased.

As described above, in the field of commercial printing, printing apparatuses that print an actual image have various surface processing functions so as to generate a highly value-added printing material. However, actually, the color management software that is embedded in the design software for generating an edition of a printing material or digital image data or an OS has not responded to management or information transfer of such surface texture of the printing material, and technology for responding to the management and the information transfer thereof has not been set up.

As approaches to the representation of the texture of the surface of the object, for example, a technology described in “Generalization of Lambert's Reflectance Model” Michael Oren and Shree K. Nayar; Department of Computer Science, Columbia University: New York, N.Y. 10027 and “A Reflectance Model for Computer Graphics” ROBERT L. COOK (Lucasfilm Ltd.) and KENNETH E. TORRANCE (Cornell University); ACM Transactions on Graphics, Vol. 1, No. 1, January 1982 have been known.

However, generally, how the texture that coincides with the texture of the printing surface of a printing material that is printed by a printing apparatus can be represented in an image displayed on a display or the like has not been considered.

### SUMMARY

An advantage of some aspects of the invention is that it provides technology for representing the texture that coincides with the texture of the printing surface of a printing material that is printed by a printing apparatus in an image displayed in a display or the like.

The invention may be implemented in the following forms or applications.

### Application 1

According to Application 1, there is provided a texture information data acquiring device that receives print data, which is used at the time of printing by using a printing apparatus and represents the amount of a print recording material used at the time of printing, as input, acquires texture information data that represents the texture of a printing surface of a printing material from the print data, and outputs the texture information data.

According to the above-described texture information data acquiring device of Application 1, the texture information data that represents the texture of the printing surface of a printing material is acquired from the print data that is used at the time of printing using the printing apparatus and represents the amount of the print recording material. The texture information data acquired as described above is data that does not depend on a device such as a printing apparatus. Accordingly, when the image display data for image display is derived from such texture information data and the image display is performed by using a display or the like, the texture that coincides with that of the printing surface of the printing material printed by the printing apparatus can be represented in an image displayed in the display or the like.

### Application 2

In the above described texture information data acquiring device of Application 1, a lookup table that represents the correspondence relationship between the value of the print data and the value of the texture information data is further included.

By using such a lookup table, the texture information data can be easily acquired from the print data.

### Application 3

In the above described texture information data acquiring device of Application 2, the correspondence relationship is derived based on the result of measurement by measuring the ratio of the intensity of reflected light to that of incident light in all directions of a half-celestial sphere for the surface of each color patch of a color chart that is printed with the print recording material.

By deriving the correspondence relationship as described above, data that does not depend on a device such as a printing apparatus can be acquired as the texture information data.

### Application 4

In the above described texture information data acquiring device of Application 1, the texture information data is represented by using parameters of a bidirectional reflectance distribution function (BRDF).

The reason for this is that the BRDF has been widely used for artificially generating a realistic image in the field of computer graphics.

### Application 5

According to Application 5, there is provided a display control system that includes the above-described texture information data acquiring device of any one of Applications 1 to 4; and an image display data deriving device that derives image display data that is used for performing image display based on the texture information data acquired by the texture information data acquiring device.

As described above, when the texture information data that does not depend on a device such as a printing apparatus is acquired by the texture information data acquiring device and the image display data used for image display is derived from the texture information data by the image display data deriving device, and the image display is performed by using a display or the like, the texture that coincides with that of the printing surface of the printing material printed by the printing apparatus can be represented in an image displayed in the display or the like.

### Application 6

In the above described display control system of Application 5, the image display data is data that can be used for a three-dimensional image display as the image display.

By using such data as image display data, the texture that coincides with that of the printing surface for a case where the printing surface is observed at a desired observation position by emitting light from a desired position of the light source can be represented in an image displayed in a display or the like.

### Application 7

According to Application 7, there is provided a method of acquiring texture information data. The method includes acquiring texture information data that represents the texture of a printing surface of a printing material from print data that is used at the time of performing printing by using a printing apparatus and represents the amount of a print recording material used at the time of printing.

According to the above-described method of Application 7, the advantages that are the same as those of Application 1 can be acquired.

### Application 8

According to Application 8, there is provided a computer program used for acquiring texture information data. The computer program implements a function of acquiring texture information data that represents the texture of a printing surface of a printing material from the print data that is used at the time of printing by using a printing apparatus and represents the amount of print recording material used at the time of printing in a computer.

According to the above-described method of Application 8, the advantages that are the same as those of Application 1 can be acquired.

Furthermore, the invention is not limited to the form of a device such as the texture information data acquiring device or the display control system described above, the form of a method such as the method of acquiring the texture information data, or the form of a computer program used for implementing the method or device described above. Thus, the invention can be implemented in various forms such as the form of a recording medium having such a computer program recorded thereon or a data signal that is implemented in a carrier wave including the above-described computer program.

### BRIEF DESCRIPTION OF THE DRAWINGS

The invention will be described with reference to the accompanying drawings, wherein like numbers reference like elements.

FIG. 1 is a block diagram showing a printing display system according to an embodiment of the invention.

FIG. 2 is a schematic block diagram showing the data processing procedure of the printing display system shown in FIG. 1.

FIG. 3 is a schematic explanatory diagram showing a lookup table that is included in texture information data acquiring section.

FIG. 4 is a schematic explanatory diagram showing the manner in which light is reflected on an object.

FIG. 5 is an explanatory diagram showing measurement geometry that is used for a BRDF.

FIG. 6 is an explanatory diagram showing four directional vectors that are defined for a microfacet.

FIGS. 7A and 7B are explanatory diagrams showing the attenuation of light due to a geometric structure.

FIG. 8 is an explanatory diagram showing another lookup table that is included in the texture information data acquiring section.

### DESCRIPTION OF EXEMPLARY EMBODIMENTS

### Configuration of Embodiment

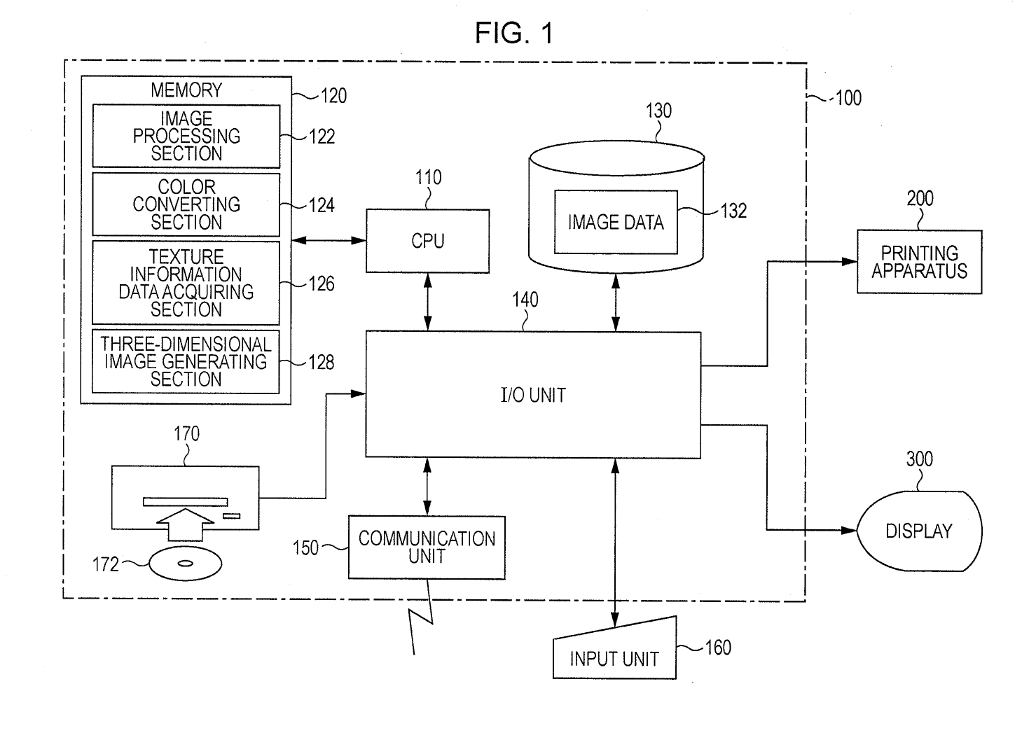

FIG. 1 is a block diagram showing a printing display system according to an embodiment of the invention. The printing display system shown in FIG. 1 is configured by a personal computer (hereinafter, simply referred to as a PC) 100 that is an image processing apparatus, a printing apparatus 200 that performs a printing operation of an image, and a display 300 that displays an image.

Among these components, the PC 100, as shown in FIG. 1, includes a CPU 110 that performs various processes and control operations by executing computer programs such as applications, a memory 120 that is used for storing the above-described computer programs or temporarily storing data or information acquired in the middle of the processes therein, a hard disk device 130 that is used for storing image data 132 and the like therein, an I/O unit 140 that is used for exchanging data or information between the CPU 110 and various peripheral devices, a communication unit 150 that is formed of a network card or the like and is used for communication with other devices through a network, an input unit 160 that is formed of a keyboard, a pointing device, or the like and is used for a user to input a direction, and an information reading unit 170 that is used for reading out information from a recording medium 172 such as a CD-ROM in which the above-described computer programs and the like are written.

The CPU 110 serves as an image processing section 122, a color converting section 124, a texture information data acquiring section 126, and a three-dimensional image generating section 128 by executing computer programs that are stored in the memory 120.

As described above, in this embodiment, a case where a CD-ROM or the like is used as a “recording medium” that stores computer programs therein so as to be readable by a computer has been described. However, as the “recording medium”, various types of a computer-readable media such as a flexible disk or an optical magnetic disk, an IC card, a ROM cartridge, a punch card, a print material in which a code such as a bar code is printed, or an internal memory device (a memory such as a RAM or a ROM) of a computer and an external memory device may be used. The computer program may be configured to be acquired by the PC from a program server by accessing the program server (not shown) that supplies computer programs through a network, instead of being provided in a form that is recorded on such a recording medium. In addition, some of the above-described computer programs may be configured by the operating system program.

In addition, the printing apparatus 200 has metallic ink in addition to cyan ink, magenta ink, yellow ink, and black ink for printing in a metallic color.

The texture information data acquiring section 126 of the PC 100 according to this embodiment corresponds to a texture information data acquiring device according to an embodiment of the invention. In addition, the three-dimensional image generating section 128 of the PC 100 corresponds to an image display data deriving device according to an embodiment of the invention.

### Operation of Embodiment

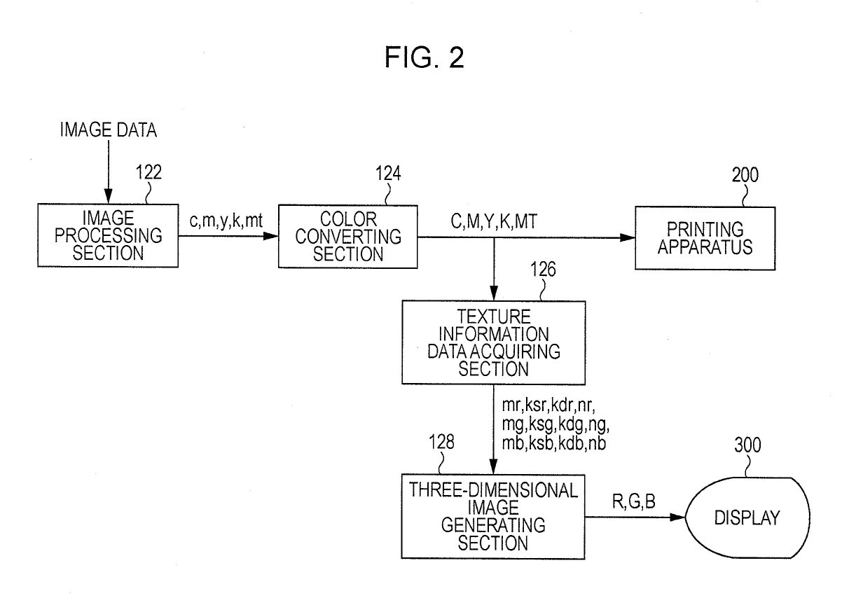

Hereinafter, the operation of this embodiment will be described with reference to FIGS. 1 and 2. FIG. 2 is a schematic block diagram showing the data processing procedure of the printing display system shown in FIG. 1.

When a user directs to print an image by designating image data 132 that is stored in the hard disk device 130 by operating the input unit 160, first, the image processing section 122 functioned by the CPU 110 reads out the image data 132 from the hard disk device 130 and performs desired image processing for the image data. Thereafter, the image processing section 122 outputs the processed image data as image record data C, M, Y, K, and MT that represents cyan, magenta, yellow, and black colors and a metallic color. Next, the color converting section 124 receives the image record data C, M, Y, K, and MT that is output from the image processing section 122 and converts the image record data into print data C, M, Y, K, and MT that represent the amounts of ink used in the printing process for inks of cyan, magenta, yellow, black and metallic that are included in the printing apparatus 200. In particular, the color converting section 124 converts the image record data into the print data so as to be adapted to the range of color reproduction of the printing apparatus 200 by using a lookup table (LUT). The print data C, M, Y, K, and MT acquired as described above is output to the printing apparatus 200. The printing apparatus 200 performs printing of an image by using inks of cyan, magenta, yellow, black and metallic on a print sheet (not shown) based on the print data C, M, Y, K, and MT. As a result, a high-value added printing material having metallic gloss and the like can be acquired. In other words, the metallic gloss and the like of the printing material are determined based on the amounts of the metallic ink and the other color inks used in the printing process. This indicates that the texture information is included in the print data that is configured by color ink and the metallic ink.

Meanwhile, the print data C, M, Y, K, and MT that has been acquired by the color converting process performed by the color converting section 124 is also output to the texture information data acquiring section 126 in addition to the printing apparatus 200. The texture information data acquiring section 126 extracts the texture information data from the input print data C, M, Y, K, and MT, for example, as a bidirectional reflectance distribution function. In this embodiment, the texture information data is represented as deviation-angle color characteristic data. In particular, the texture information data is represented by using the parameters of a bidirectional reflectance distribution function (BRDF). Here, the BRDF is a physical amount that is acquired by describing the relationship between the incident light and the reflected light in all the directions of a half celestial sphere for an arbitrary observation point on the target surface of an object. Since the “optical BRDF” that is, the BRDF measured based on the spectroscopic characteristics, can describe the color of an object and the characteristics of the reflection thereof, the “optical BRDF” has already been widely used for artificially generating a realistic image in the computer graphics field.

In this embodiment, as the parameters of the BRDF, in order to respond to image display, four parameters m, kₛ, k_{d}, and n are prepared for each colors of red (R), green (G), and blue (B). Among these parameters, m is a coefficient that represents the surface roughness of an object, kₛ is a coefficient relating to the surface reflectance ρₛ of an object, k_{d} is a coefficient relating to the internal diffuse reflectance ρ_{d} of an object, and n is a refractive index of an object. These will be described in detail later.

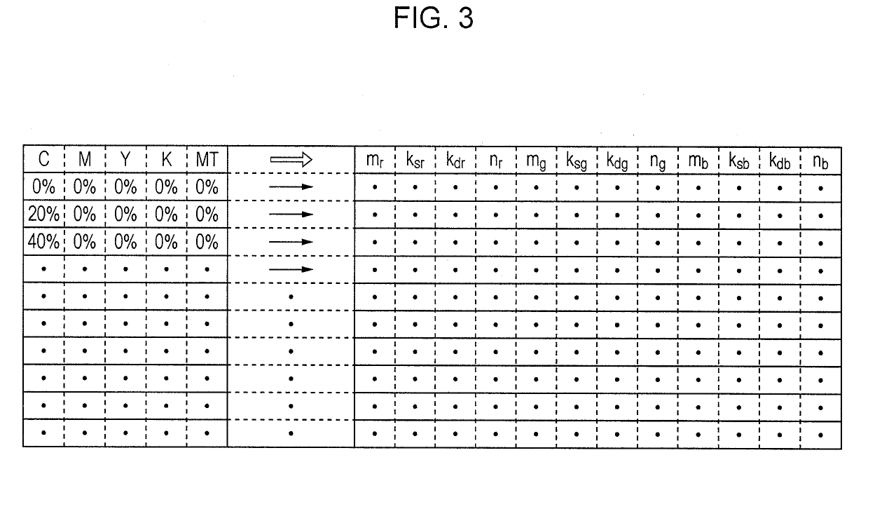

The texture information data acquiring section 126 includes a lookup table and an interpolation calculating part (not shown). FIG. 3 is a schematic explanatory diagram showing the lookup table that is included in the texture information data acquiring section 126. This lookup table represents the relationship between the print data C, M, Y, K, and MT as inputs and the texture information data mᵣ, kₛᵣ, k_{dr}, nᵣ, m_{g}, k_{sg}, k_{dg}, n_{g}, m_{b}, k_{sb}, k_{db}, and n_{b} as outputs. Among these, mᵣ, kₛᵣ, k_{dr}, and nᵣ are parameters relating to red (R), m_{g}, k_{sg}, k_{dg}, a n_{g} are parameters relating to green (G), and m_{b}, k_{sb}, k_{db}, and n_{b} are parameters relating to blue (B).

In FIG. 3, C, M, Y, K, and MT shown on the left side are the print data as the inputs, and mᵣ, kₛᵣ, k_{dr}, nᵣ, m_{g}, k_{sg}, k_{dg}, n_{g}, m_{b}, k_{sb}, k_{db}, and n_{b} shown on the right side are the texture information data as the outputs. In other words, when the values of one set of the print data C, M, Y, K, and MT are input to this lookup table, the lookup table outputs values of one set of the texture information data mᵣ, kₛᵣ, k_{dr}, nᵣ, m_{g}, k_{sg}, k_{dg}, n_{g}, m_{b}, k_{sb}, k_{db}, and n_{b} (denoted by right arrows) corresponding to the input set. In addition, values of a set that are not stored in this lookup table are derived by the interpolation calculating part (not shown) that performs interpolation calculation by using values of sets that are close to the values of the input set.

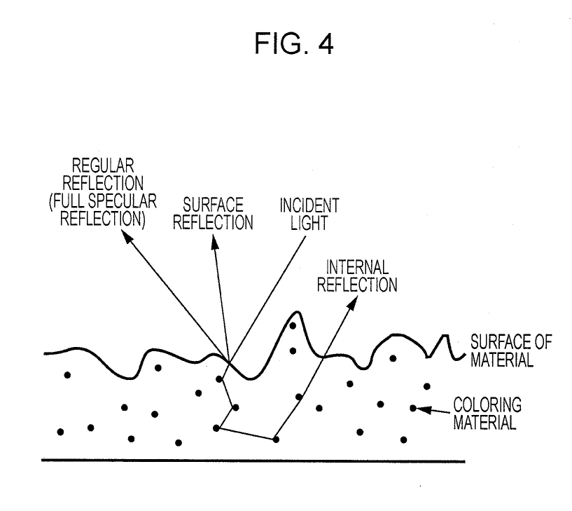

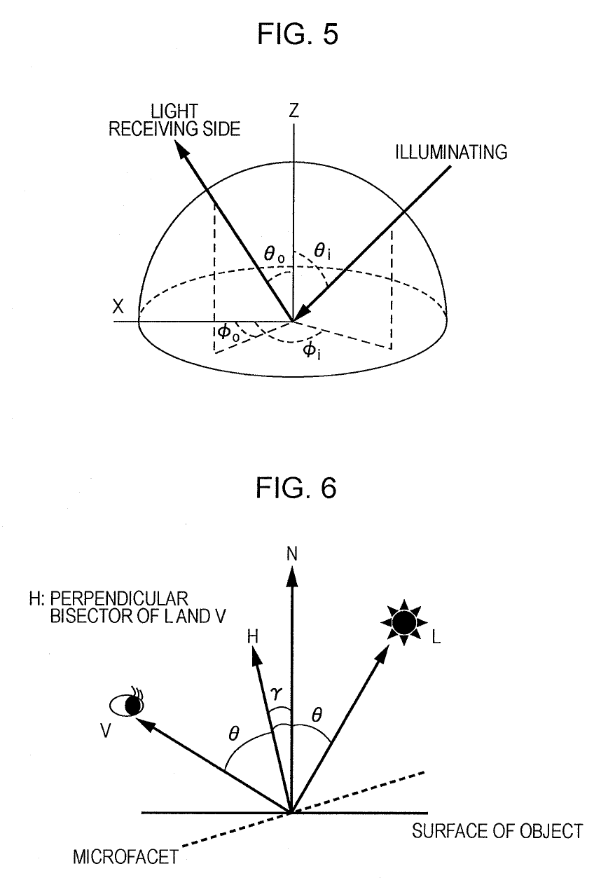

FIG. 4 is a schematic explanatory diagram showing the manner in which light is reflected on an object. FIG. 5 is an explanatory diagram showing the measurement geometry that is used for the BRDF.

As shown in FIG. 4, when a non-uniform object is irradiated by a light source, light is largely divided into light that is reflected from the surface of the object and reflected light that travels to the inside of the object so as to be scattered inside the object and exits from the surface of the object. The BRDF is a physical amount acquired by measuring the ratio (the reflectance ratio, the spectral reflection factor for spectrum light) of the intensity of the reflected light to the intensity of the incident light for one point positioned on the surface of the object in all directions of the half celestial sphere. In addition, the BRDF is measured by a three-dimensional variable-angle measuring device based on the measurement geometry as shown in FIG. 5. In FIG. 5, φᵢ is the angle of the incident light with respect to the X axis, θᵢ is the angle of the incident light with respect to the Z axis, φₒ is the angle of the reflected light with respect to the X axis, and θₒ is the angle of the reflected light with respect to the Z axis.

The correspondence relationship between the print data and the texture information data that is used as the lookup table for the texture information data acquiring section 126 shown in FIG. 3 can be acquired as follows. First, a color chart is printed by using ink such as cyan, magenta, yellow, black and metallic ink that is used by the printing apparatus 200. Then, for each color patch of the color chart, the ratio of the intensity of the reflected light to the intensity of the incident light for the surface of the color patch is measured in all directions of the half celestial sphere by using the above-described three-dimensional variable-angle measuring device, and the parameters of the BRDF are calculated based on the measured result. Then, for each color patch, the correspondence relationship between the print data and the texture information data is derived based on the correspondence relationship between each amount of the ink used in the printing process and the calculated parameters m, k_{s, k}_{d}, and n of the BRDF.

Next, the three-dimensional image generating section 128 derives the image display data R, G, and B that represent the red, green, and blue colors to be input to the display 300 by using the acquired texture information data, that is, the parameters of the BRDF acquired by the texture information data acquiring section 126.

Hereinafter, a method of deriving the image display data R, G, and B from the parameters of the BRDF will be described. Here, the R component of the image display data R, G, and B will be described about, representatively.

When the parameters of the BRDF acquired from the lookup table by the texture information data acquiring section 126 are as shown in Numeric Expression 1, the R component of the image display data, as represented in Equation (1), is represented as a value that is dependent on the angles φᵢ, θᵢ of the incident light and the angles φₒ, θₒ of the reflected light which are represented in FIG. 5.

└mᵣ, kₛᵣ, k_{dr}, nᵣ, m_{g}, k_{sg}, k_{dg}, n_{g}, m_{b}, k_{sb}, k_{db}, n_{b}┘ Numeric Expression 1

Equation (1)

R(φₒ, θₒ, φᵢ, θᵢ)=k_{dr}ρ_{d}+Kₛᵣρₛ(φₒ, θₒ, φᵢ, θᵢ) (1)

Here, ρ_{d}, as described above, is the internal diffuse reflectance, ρs is the surface reflectance, and kₛᵣ and k_{dr} are coefficients (kₛᵣ+k_{dr}=1). In addition, ρₛ(φₒ, θₒ, φᵢ, θᵢ) represented in Equation (1) is calculated by using Equation (2).

$$\begin{matrix}Equation ( 2 ) & \\ {ρ}_{s} ( {ϕ}_{o} , {θ}_{o} , {ϕ}_{i} , {θ}_{i} ) = \frac{F ( θ ) D ( m , γ ) G}{( N \cdot V ) ( N \cdot L )} \\ ( here , “ \cdot ” denotes an inner product of vectors ) & ( 2 )\end{matrix}$$

Among these, D(m, γ) represents a microfacet distribution function, G represents a geometric attenuation coefficient, and F(θ) represents Fresnel reflectance.

First, the microfacet distribution function D(m, γ) will be described. FIG. 6 is an explanatory diagram showing four directional vectors that are defined for a microfacet.

When microfacets are assumed to form concavity and convexity of the surface of the object, the microfacets face various directions. Accordingly, the distribution of the directions of the microfacets represents the distribution of luminance of the specular light due to the roughness of the surface. The direction of the microfacet, as shown in FIG. 6, is described by a vector H (half vector) of the perpendicular bisector of a light source directional vector L and an observation directional vector V. Represented in an equation, the half vector H is defined by using Equation (3). Here, a vector N is a normal-line vector for the surface of the object.

$$\begin{matrix}Equation ( 3 ) & \\ H = \frac{L + V}{‖ L + V ‖} & ( 3 )\end{matrix}$$

There are various microfacet distribution functions D(m, γ). As a representative microfacet distribution function, a Beckmann distribution function is known, which is represented by using Equation 4.

$$\begin{matrix}Equation ( 4 ) & \\ \begin{matrix}D ( m , γ ) = \frac{1}{4 {m}^{2} {cos}^{4} γ} exp \{ - {( \frac{tan γ}{m} )}^{2} \} \\ = \frac{1}{4 {m}^{2} {cos}^{4} γ} exp \{ - \frac{1 - {cos}^{2} γ}{{m}^{2} {cos}^{2} γ} \}\end{matrix} & ( 4 )\end{matrix}$$

Here, m, as described above, is a coefficient that represents the roughness of the surface. As the m value of a surface becomes larger, the surface becomes rougher. In such a case, the distribution function acquires a shape that is spatially broadened.

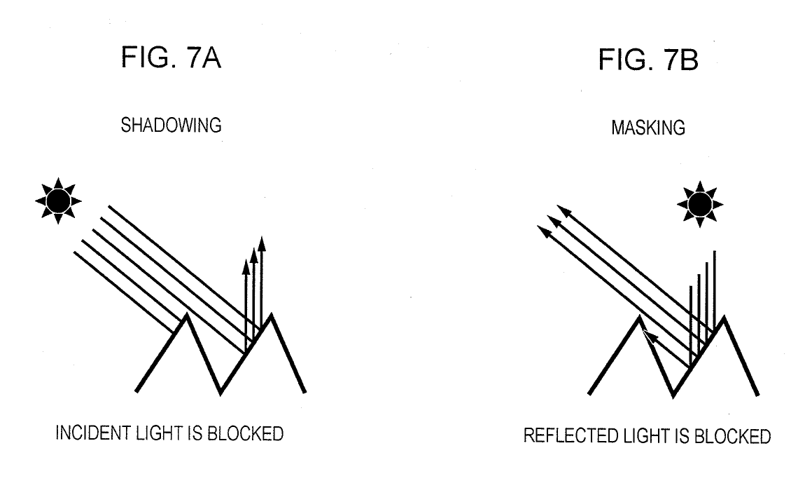

Next, the geometric attenuation coefficient G will be described. FIGS. 7A and 7B are explanatory diagrams showing the attenuation of light due to the geometric structure.

When it is assumed that the concavity and convexity of the surface of the object face various directions, as shown in FIGS. 7A and 7B, there are cases where the light is blocked at the time of incidence or reflection. A case (FIG. 7A) where the light is blocked at the time of incidence is referred to as “Shadowing”, and a case (FIG. 7B) where the light is blocked at the time of reflection is referred to as “Masking”. In both cases, the intensity of the light is attenuated.

When the case of “Shadowing” (FIG. 7A) and the case of “Masking” (FIG. 7B) are formulated by respectively using the four directional vectors that are defined in FIG. 6, the cases can be represented as follows.

For the case of “Shadowing” (FIG. 7A)

$$\begin{matrix}Equation ( 5 ) & \\ {G}_{Shadow} = \frac{2 ( N \cdot H ) ( N \cdot L )}{V \cdot H} & ( 5 )\end{matrix}$$

For the case of “Masking” (FIG.B)

$$\begin{matrix}Equation ( 6 ) & \\ {G}_{Mask} = \frac{2 ( N \cdot H ) ( N \cdot V )}{V \cdot H} & ( 6 )\end{matrix}$$

In a case where light is not blocked at all, there is no attenuation. Thus, the value of the geometric attenuation coefficient G is set to “1”. On the other hand, when the intensity of the light is assumed to be attenuated between zero and one in a case where the light is blocked by either Shadowing or Masking, the state shown in FIGS. 7A and 7B can be represented by an attenuation factor that is influenced by the geometric structure and can be defined as the geometric attenuation coefficient G The range of this attenuation coefficient G is zero to one. Thus, the attenuation coefficient G is not larger than one and can be represented by using the following Equation (7).

Equation (7)

G=min {1,G_{Shadow}, G_{Mask}} (7)

Next, the Fresnel reflectance F will be described. When the light is incident to the surface of an object, the light is divided into reflected light from the surface and light that is refracted so as to travel to the inside of the object. The ratio of the reflected light to the refracted light changes depending on the angle of incidence. The reflection occurring on the surface of the object in such a case is referred to as Fresnel reflectance. The Fresnel reflectance F(θ) can be represented by the following Equation (8).

$$\begin{matrix}Equation ( 8 ) & \\ F ( θ ) = \frac{1}{2} \frac{{( g - c )}^{2}}{{( g + c )}^{2}} [ 1 + {\{ \frac{c ( g + c ) - 1}{c ( g + c ) + 1} \}}^{2} ] \\ c = cos θ = ( V \cdot H ) = ( L \cdot H ) \\ {g}^{2} = {n}^{2} + {c}^{2} - 1 & ( 8 )\end{matrix}$$

Here, n, as described above is the refractive index of the object.

As above, the microfacet distribution function D(m,γ), the geometric attenuation coefficient G, and the Fresnel reflectance F(θ), as shown in Equation (2), have been described.

Accordingly, by substituting m of Equation (4) with mᵣ out of the four parameters mᵣ, kₛᵣ, k_{dr}, and nᵣ of the BRDF parameters (that is, the texture information data), which are acquired by the texture information data acquiring section 126, for the R Component and substituting n of Equation (8) with nr of the parameters, ρₛ(φₒ,θₒ,φᵢθᵢ) for the R component shown in Equation (1) is calculated.

In Equation (1), ρ_{d} does not depend on the direction of reflection but has a constant value of (N·L), and the term of the k_{dr}.ρ_{d} changes only depending on the value of k_{dr}.

As described above, the R component R(φₒ,θₒ,φᵢ,θᵢ) of the image display data can be derived based on Equation (1) by using the four parameters mᵣ, kₛᵣ, k_{dr}, and nᵣ of the BRDF parameters for the R component. In addition, the G component G(φₒ,θₒ,φᵢθᵢ) and the B component B(φₒ,θₒ,φᵢ,θᵢ) similarly to the R component, can be derived by performing the above-described calculation process.

Any one of the R, G, and B components of the image display data that are derived as described above is represented as a value that depends on the angles φᵢ and θᵢ of the incident light and the angles φₒ and θₒ of the reflected light that are represented in FIG. 5.

Thus, when a user indicates, for example, the position of the light source and the position of observation by operating the input unit 160, the three-dimensional image generating section 128 calculates the angles φᵢ and θᵢ of the incident light and the angles φₒ and θₒ of the reflected light that are represented in FIG. 5 based on the designated positions and uniquely determines the values of the R, G, and B components of the image display data based on the calculated angles.

The image display data R, G, and B derived by the three-dimensional image generating section 128 as described above is output to the display 300. Then, the display 300 performs display of the image based on the image display data. When the user changes the position of the light source or the position of the observation by operating the input unit 160 further, the display of the image is changed into three-dimensions in accordance with the change, whereby the display of a three-dimensional image can be performed. Such a function of the three-dimensional image generating section 128, for example, may be implemented by using an application program such as “Auto desk Maya” or “nStyler” that is 3D CAD software.

As described above, in this embodiment, the texture information data acquiring section 126 acquires the texture information data, which represents the texture of the printing surface of the printing material printed by the printing apparatus 200, based on the print data C, M, Y, K, and MT input to the printing apparatus 200, which depends on the printing apparatus 200, instead of depending on a device such as the printing apparatus 200, and the image display data R, G, and B that is to be input to the display 300 is derived based on the texture information data so as to display a three-dimensional image in the display 300. As a result, a three-dimensional image that is the same as the image printed on the printing material can be displayed on the screen by the display 300. In other words, the texture that coincides with the texture of the printing surface of the printing material printed by the printing apparatus 200 can be represented as an image displayed in the display 300.

### Modified Examples

The invention is not limited to the above-described embodiment or example and may be performed in various forms within the scope not departing from the basic idea thereof.

### Modified Example 1

In the above-described embodiment, the texture information data acquiring section 126 is configured to use the four parameters m, kₛ, k_{d}, and n for each color of the R, G, and B as the texture information data (that is, the parameters of the BRDF). However, the invention is not limited thereto. Thus, the parameters m and n may be configured to be used commonly for the R, G, and B colors. In such a case, the parameters of the BRDF are m, n, kₛᵣ, k_{dr}, k_{sg}, k_{dg}, k_{sb}, and k_{db}. In addition, even when the parameters m and n are configured to be commonly used for the R, G, and B colors, the R component R(φₒ,θₒ,φᵢ,θᵢ), the G component G(φₒ,θₒ,φᵢ,θᵢ) and the B component B(φₒ,θₒ,φᵢ,θᵢ) of the image display data can be calculated by using Equations (1) to (8).

### Modified Example 2

In the above-described embodiment, the texture information data acquiring section 126 is configured to acquire the texture information data from the print data C, M, Y, K, and MT. However, the invention is not limited thereto. Thus, the texture information data acquiring section 126 may be configured to acquire color information data together with the texture information data.

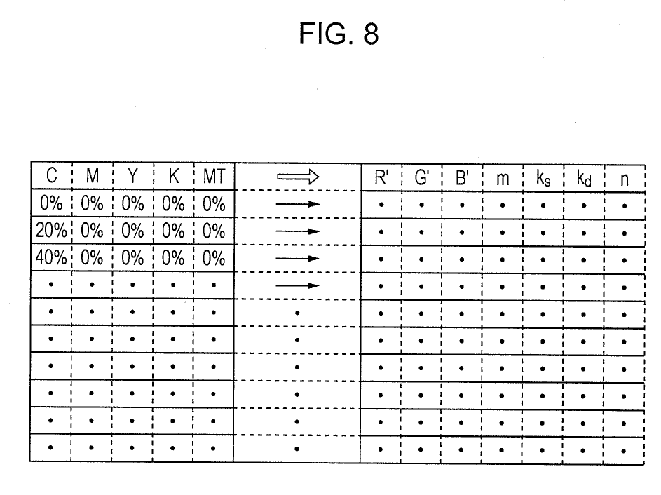

FIG. 8 is an explanatory diagram showing another lookup table that is included in the texture information data acquiring section 126. This lookup table represents the correspondence relationship between the print data C, M, Y, K, and MT as input and the color information data R′, G′ and B′ and the texture information data (that is, the parameters of the BRDF) as output. Among these, the texture information data m, kₛ, and k_{d}, are parameters relating to the luminance I. Then, the three-dimensional image generating section 128 derives the image display data R, G and B to be input to the display 300 by using the color information data R′, G′, and B′ and the texture information data m, kₛ, k_{d}, and n that are acquired as described above.

### Modified Example 3

In the above-described embodiment, the printing apparatus 200 is configured to use metallic ink for representing the metallic color. However, the invention is not limited thereto. Thus, the printing apparatus 200 may be configured to use clear ink, ultraviolet-curable ink, or the like, instead of or together with the metallic ink. In such a case, data corresponding to amount of the clear ink or the ultraviolet-curable ink at the time of the printing process is additionally input to the printing apparatus 200 and the texture information data acquiring section 126 as print data.

In addition, the printing apparatus 200 may be configured to use only ordinary ink such as cyan, magenta, yellow and black ink, instead of using special ink such as metallic, clear, ultraviolet-curable, or the like. In such a case, naturally, only data (for example, C, M, Y, and K only) relating to the ordinary ink is input to the printing apparatus 200 and the texture information data acquiring section 126 as print data. At that moment, the texture information data acquiring section 126 may be configured to acquire the texture information data (that is, the parameters of the BRDF) m, kₛ, k_{d}, and n from the input print data C, M, Y, and K.

### Modified Example 4

In the above-described embodiment, the printing apparatus 200 is configured to use ink as a print recording material. However, the printing apparatus 200 may be configured to use a different recording material such as toner.

### Modified Example 5

In the above-described embodiment, the texture information data is represented by using the parameters of the BRDF. However, the texture information data may be represented by using a different index such as the degree of gloss, the degree of the metallic property, or the degree of concavity and convexity.

### Modified Example 6

In the above-described embodiment, the texture information data is used for deriving the image display data. However, the invention is not limited thereto. Thus, the texture information data may be configured to be directly stored, transferred, or processed or may be used for evaluating the texture. In addition, the texture information data may be used for acquiring print data of a different format. Thus, the PC 100 is configured to include at least the texture information data acquiring section 126 and needs not to include the three-dimensional image generating section 128 necessarily.

In the above-described embodiment, the print data is configured as C, M, Y, K, and MT. However, C, M, Y, and MT may be used as well.

This application claims priority to Japanese Patent Application No. 2008-283313, filed Nov. 4, 2008, the entirety of which is incorporated by reference herein.

What is claimed is:

1. A texture information data acquiring device that receives print data, which is used at the time of printing by using a printing apparatus and represents the amount of a print recording material used at the time of printing, as input, acquires texture information data that represents the texture of a printing surface of a printing material from the print data, and outputs the texture information data.

2. The texture information data acquiring device according to claim 1, further comprising a lookup table that represents the correspondence relationship between the value of the print data and the value of the texture information data.

3. The texture information data acquiring device according to claim 2, wherein the correspondence relationship is derived based on the result of measurement by measuring the ratio of the intensity of reflected light to that of incident light in all directions of a half-celestial sphere for the surface of each color patch of a color chart that is printed with the print recording material.

4. The texture information data acquiring device according to claim 1, wherein the texture information data is represented by using parameters of a bidirectional reflectance distribution function (BRDF).

5. A display control system comprising:
ture information data acquiring device according to claim 1; and
an image display data deriving device that derives image display data that is used for performing image display based on the texture information data acquired by the texture information data acquiring device.

6. The display control system according to claim 5, wherein the image display data is data that can be used for a three-dimensional image display as the image display.

7. A method of acquiring texture information data, the method comprising acquiring texture information data that represents the texture of a printing surface of a printing material from print data that is used at the time of performing printing by using a printing apparatus and represents the amount of a print recording material used at the time of printing.

8. A computer program product used for acquiring texture information data, the computer program product implements a function of acquiring texture information data that represents the texture of a printing surface of a printing material from print data that is used at the time of performing printing by using a printing apparatus and represents the amount of a print recording material used at the time of printing, in a computer.
